(19) United States
(12) Patent Application Publication
(10) Pub. No.: US 2026/0342626 A1
(43) Pub. Date: Oct. 29, 2026

(54) START BIT DETECTION FOR SYNCHRONIZING DECODERS

(71) Applicant: STMicroelectronics International N.V., Geneva (CH)

(72) Inventors: Giovanni Amedeo Cirillo, Torino (IT); Gianluca De Piano, Serino (AV) (IT); Alessandro Alaimo, Vecchiano (IT)

(21) Appl. No.: 19/193,725

(22) Filed: Apr. 29, 2025

(51) Int. Cl. H04L 27/12; H04L 27/148

(52) U.S. Cl. CPC H04L 27/12; H04L 27/148

(57) ABSTRACT

According to an embodiment, a system for start bit detection in wireless power transfer communication includes a data retriever circuit that acquires information from an ASK demodulator and a start bit recognition circuit that identifies the first binary zero following a preamble sequence. The start bit recognition circuit updates a controller, decoder, and bitstream generator to ensure proper alignment to bit boundaries. The system may employ a comb filter that calculates the difference between current samples and samples from half a bit interval earlier or a slicer coupled with a moving sum filter corresponding to a matched filter for biphase-mark coded binary zero. For interval-based decoding, the system measures intervals between signal edges, with a preamble detector counting consecutive half-bit intervals and a start bit recognition circuit identifying the first full-bit interval.

### TECHNICAL FIELD

The present disclosure generally relates to electronic devices and, in particular embodiments, to start bit detection for synchronizing decoders.

### BACKGROUND

Wireless power transfer systems enable the transmission of electrical energy from a power transmitter to a power receiver without physical connections. These systems typically operate through inductive coupling between coils, where a primary coil in the power transmitter generates a magnetic field that induces a current in a secondary coil in the power receiver. In wireless power transfer systems compliant with standards such as Qi, communication between the power receiver and power transmitter occurs through backscatter modulation, where the power receiver modulates the load impedance of its coil to create detectable variations in the power transmitter's coil.

The modulation technique commonly employed in these systems is Amplitude Shift Keying (ASK), which utilizes biphase-mark coding (BMC) synchronized with a clock signal operating at approximately 2 kHz. In this coding scheme, a binary ‘0’ appears as a rectangular pulse over the bit period, while a binary ‘1’ appears as a square wave with an additional transition at the middle of the bit period. Communication messages begin with a preamble of consecutive binary ‘1’ values, followed by a start bit (always ‘0’), one data byte, a parity bit, and a stop bit (always ‘1’).

The demodulation process in the power transmitter involves signal processing steps, including analog-to-digital conversion, baseband conversion, filtering, and DC removal to extract the modulated information. A slicer circuit performs binary decisions on the processed signal, compressing the information to binary values. Decoding approaches may include interval-based methods, where time intervals between signal edges determine bit values, or similarity score techniques, where the received signal is compared against matched filters representing possible bit combinations.

Conventional approaches to the message decoding associated with ASK demodulation in wireless power transfer systems often employ methods that sample the demodulated signal at twice the bit rate, providing only two samples per bit period. These approaches typically rely on statistical or sequence-matching methods for detecting similarities between input bits and expected reference patterns, often involving complex minimum searches within moving observation windows. Such methods may introduce ambiguities due to potential misalignment between modulation edges and the decimator, particularly when limited to just two samples per bit. Additionally, these conventional systems frequently require mandatory phase alignment circuits to compensate for these limitations.

### SUMMARY

Technical advantages are generally achieved by embodiments of this disclosure, which describe start bit detection for synchronizing decoders.

A first aspect relates to a method for demodulating and decoding a signal in a wireless power transfer system, the method comprising detecting a preamble sequence by processing a demodulated signal corresponding to a demodulation of an amplitude shift keying (ASK) modulated signal, the preamble sequence comprising a series of consecutive binary ones encoded using biphase mark coding; monitoring for a start bit in response to detecting the preamble sequence, wherein the start bit comprises a binary zero following the preamble sequence; and performing decoding aligned to bit boundaries of subsequent data bits following the start bit.

A second aspect relates to a circuit for synchronizing decoding in a wireless power transfer system, the circuit comprising a data retriever circuit configured to extract a signal for a start bit recognition, the signal associated with a demodulated amplitude shift keying (ASK) signal; a start bit recognition circuit coupled to the data retriever circuit and configured to detect a start bit of the signal comprising a biphase mark zero following a preamble sequence of the signal, and generate update signals in response to detecting the start bit; and a controller circuit configured to receive one of the update signals from the start bit recognition circuit and provide samples to a decoder circuit aligned to bit boundaries of subsequent data bits following the start bit.

A third aspect relates to a device for wireless power transfer, the device comprising an amplitude shift keying (ASK) digital signal processing (DSP) circuit configured to generate a demodulated ASK signal from an ASK modulated signal, wherein carrier modulation is handled by a power receiver external to the device; a controller circuit coupled to the ASK DSP circuit; a decoder circuit coupled to the controller circuit; a bitstream generator circuit coupled to the decoder circuit; a data retriever circuit coupled to the ASK DSP circuit, the controller circuit, and the decoder circuit, the data retriever circuit configured to extract a signal for a start bit recognition and associated with the demodulated ASK signal; and a start bit recognition circuit coupled to the data retriever circuit and configured to detect a start bit comprising a biphase mark zero following a preamble sequence of the signal, and provide update signals to the controller circuit, the decoder circuit, and the bitstream generator circuit in response to detecting the start bit to synchronize decoding operations to bit boundaries of subsequent data bits following the start bit.

Embodiments can be implemented in hardware, software, or any combination thereof.

### BRIEF DESCRIPTION OF THE DRAWINGS

For a more complete understanding of the present disclosure and the advantages thereof, reference is now made to the following descriptions taken in conjunction with the accompanying drawings, in which:

FIG. 1 is a block diagram of an embodiment wireless power system, which may also be called a wireless charging system;

FIG. 2 is a block diagram of an embodiment receiving device;

FIG. 3 is a block diagram of an embodiment transmitting device;

FIG. 4 is a schematic of an embodiment sensing circuit;

FIG. 5 is a circuit diagram of an embodiment demodulator circuit;

FIG. 6 is a block diagram of an embodiment decoder circuit for processing ASK modulated signals in wireless power transfer systems;

FIG. 7 is an embodiment controller circuit;

FIG. 8 is an embodiment decoder circuit for start bit recognition in wireless power transfer communication systems;

FIG. 10 is an embodiment start bit recognition circuit;

FIG. 11 is an example waveform diagram 1100 depicting the operation of the start bit recognition circuit;

FIG. 12 is an embodiment start bit recognition circuit;

FIG. 13 is an example waveform diagram depicting the operation of the start bit recognition circuit, with the absolute value on the moving sum output performed;

FIG. 14 is a block diagram of an embodiment comparator circuit;

FIG. 15 is a block diagram of an embodiment preamble detector circuit; and

FIG. 16 is a block diagram of an embodiment controller.

### DETAILED DESCRIPTION OF ILLUSTRATIVE EMBODIMENTS

This disclosure provides many applicable inventive concepts that can be embodied in a wide variety of specific contexts. The particular embodiments are merely illustrative of specific configurations and do not limit the scope of the claimed embodiments. Features from different embodiments may be combined to form further embodiments unless noted otherwise. Various embodiments are illustrated in the accompanying drawing figures, where identical components and elements are identified by the same reference number, and repetitive descriptions are omitted for brevity.

Variations or modifications described in one of the embodiments may also apply to others. Further, various changes, substitutions, and alterations can be made herein without departing from the spirit and scope of this disclosure as defined by the appended claims.

While the aspects described in this disclosure are primarily in the context of wireless power transfer systems using Amplitude Shift Keying (ASK) modulation, it should also be appreciated that these aspects may also apply to other communication systems utilizing biphase-mark coding. In particular, aspects of this disclosure may similarly apply to various digital communication protocols where signal synchronization and bit boundary detection are implemented, such as near-field communication (NFC) systems, radio frequency identification (RFID) applications, and other low-power wireless communication technologies.

Embodiments of the disclosure are directed at recognizing the start bit and aligning data stream decoding in wireless power transmitters. The disclosure addresses challenges in synchronizing decoders to the correct bit boundaries when processing Amplitude Shift Keying (ASK) modulated signals with biphase-mark coding.

In wireless power transfer systems, communication between power receivers and power transmitters occurs through backscatter modulation using ASK signals. The preamble of these communications consists of consecutive binary ones, followed by a start bit that is always a binary zero. Due to initial transients in demodulation filters and ambiguities in the biphase-mark coding, in particular when the preamble is constituted only by logic ones, conventional systems may misalign to half-bit boundaries instead of true bit boundaries, leading to decoding errors.

Aspects of the disclosure include a data retriever that acquires information from various components of the ASK demodulator and provides data to a start bit recognition circuit. The start bit recognition circuit identifies the first bit (logic or binary zero) following the preamble. It updates the controller of samples for the decoder, the decoder itself, and the decoded bitstream generator. This approach can ensure proper alignment to bit boundaries for accurate decoding.

In some embodiments, a preamble detector functions as the data retriever, enabling the start bit recognition after detecting the preamble sequence. The start bit recognition may utilize a comb filter applied to the demodulated ASK signal, which performs the difference between current samples and samples from half a bit interval earlier. When processing preamble bits (binary ones), the absolute value of this difference remains significant, but when processing the start bit (binary zero), the difference approaches zero, allowing for reliable detection. If the absolute value is not considered when preamble bits are processed, the difference is expected to be significantly positive or negative (depending on the polarity of the samples involved in the subtraction). In contrast, in the presence of the start bit, it is expected to be close to zero.

In embodiments, a slicer coupled with a moving sum filter may be employed. The slicer produces a normalized waveform, and the moving sum over a bit interval corresponds to a matched filter for the biphase-mark coded binary zero. When the absolute value of the moving sum exceeds a programmable threshold, the system recognizes the start bit and synchronizes the decoder accordingly. If the absolute value is not considered when preamble bits are processed, the moving sum is expected to be zero (or close to zero). In contrast, in presence of the start bit, it is expected to be positive or negative (depending on the polarity of the signal when the preamble bit arrives) significantly different from zero.

For interval-based decoding implementations, the system can measure intervals between signal edges or can extract a metric associated with the same intervals. The preamble detector counts consecutive intervals corresponding to half-bit durations. At the same time, the start bit recognition waits for the first interval, matching a full-bit duration, indicating the start bit has been detected.

Compared to conventional approaches that enable decoders twice per bit interval to overcome synchronization issues, embodiments of the disclosure reduce power consumption by enabling the decoder only once per bit interval after proper alignment. This improvement results from leveraging the known characteristics of the start bit to eliminate bit boundary ambiguities. These and additional details are further discussed below.

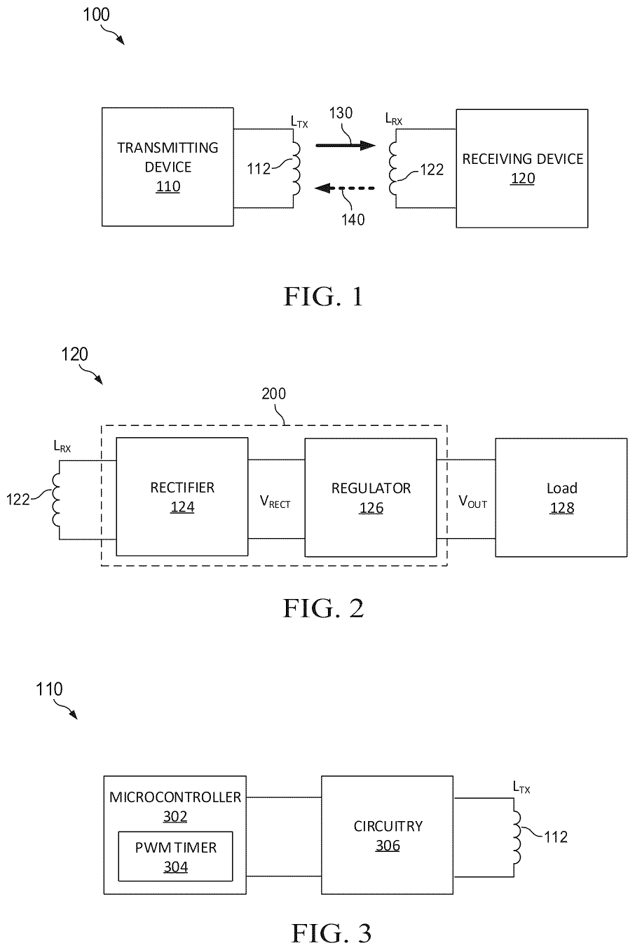

FIG. 1 illustrates a block diagram of an embodiment wireless power system 100, which may also be called a wireless charging system. The system includes a transmitting device 110 and a receiving device 120, which may (or may not) be arranged as shown. The transmitting device 110 generates and transmits wireless energy 130 to the receiving device 120.

The transmitting device 110 may be a base station, such as a charging pad, which provides inductive power to the receiving device 120. The receiving device 120 can be, for example, a mobile device, a tablet, a cellular phone, a wearable communications device (e.g., a smartwatch), a digital pen, a wireless headphone, a toothbrush, a sensor, an internet of things (IoT) device, or the like. The receiving device 120 is the consumer of inductive power.

The transmitting device 110 includes a transmitter coil 112 (L_{TX}). The receiving device 120 includes receiver coil 122 (L_{RX}). Each coil, or winding, can be a loop or magnetic antenna. The coils may have a physical core (e.g., ferrite core) or an air core. The coils may be implemented as an antenna strip or using a Litz wire. The resonant frequency of each coil is based on the shape and size of the looping wire or coil. In some embodiments, additional capacitance and inductance may be added to each coil to create a resonant structure at the desired resonant operating frequency.

In embodiments, the wireless energy 130 is transmitted from the transmitting device 110 to the receiving device 120 using a resonant inductive coupling between the transmitter coil 112 and the receiver coil 122. The receiving device 120 may use the power to charge rechargeable batteries or power the components within it directly.

The wireless power system 100 also includes a backscatter communication link 140, represented by the dashed arrow, from the receiving device 120 to the transmitting device 110. The backscatter communication link 140 allows the receiving device 120 to communicate information back to the transmitting device 110, which can be used for power control, device identification, or other purposes.

FIG. 2 illustrates a block diagram of an embodiment receiving device 120. The receiving device 120 includes the receiver coils 122, a power charging circuit 200, and a load 128. The power charging circuit 200 includes a rectifier 124 and a regulator 126. The receiving device 120 may include additional components not depicted in FIG. 2, such as long-term storage (e.g., non-volatile memory, etc.), a non-transitory computer-readable medium, one or more antenna elements, drivers, demodulators, modulators, filter circuits, and impedance matching circuits.

The rectifier 124 converts the alternating current (AC) voltage at the receiver coils 122 to a direct current (DC) voltage. It may be any type of rectifier, such as a low-impedance synchronous rectifier having full-wave or half-wave rectification or an active rectifier. In embodiments, the rectifier 124 may be a bridge rectifier; however, other types of rectifiers are also contemplated.

The regulator 126 receives a voltage (V_{RECT}) from the rectifier 124 and then regulates that voltage to maintain a constant output voltage (V_{OUT}) at load 128. The regulator 126 may be any type of voltage regulator, such as a linear regulator (e.g., low drop-out (LDO) linear regulator). In some embodiments, the rectifier 124 and the regulator 126 may be part of a switched-mode power supply (SMPS) circuit.

As shown, load 128 is the primary benefactor of the transferred wireless energy 130. The load 128 may be a battery or a charge storage device, such as a cellular phone or smart watch battery. For example, the transmitting device 110 may be a charging pad and a smartwatch may be placed on the charging pad—the charging pad transfers wireless power to the smartwatch's battery without connecting cables between the two devices.

Several interface standards have been developed to standardize wireless power transfer and related functions. One such interface standard is Qi, which the Wireless Power Consortium (WPC) promotes. Qi and similar standardized protocols may be used to define the communication interface for controlling the power transfer in the wireless power system 100. For instance, the receiving device 120 may request a change (e.g., an increase, a decrease, a pause, etc.) related to the transferred wireless energy 130 from the transmitting device 110.

The mechanism of inductive power transfer can also be utilized for communication between the transmitting device 110 and the receiving device 120. For example, the receiving device 120 can inform the transmitting device 110 when the charging process is complete. This communication can be facilitated through a technique known as backscatter modulation, as specified in the Qi Standard for inductive wireless power transfer.

In practice, the receiving device 120 can alter its load impedance by, for example, changing the impedance of the load 128. The change in the impedance results in observable variations in the amplitude of the current or voltage in the transmitter coil 112, due to the mutual inductance obtained when the two coils are arranged sufficiently close to each other, allowing information to be transmitted from the receiving device 120 to the transmitting device 110 and consequently implementing the backscatter communication link 140.

FIG. 3 illustrates a block diagram of an embodiment transmitting device 110. The transmitting device 110 includes a microcontroller 302, additional circuitry 306, and the transmitter coil 112, which may (or may not) be arranged as shown. Transmitting device 110 may include memory for storage. In embodiments, microcontroller 302 includes embedded memory. In embodiments, the PWM timer circuit 304 is embedded within the microcontroller 302.

Generally, a digital modulation scheme represents digital data using a finite number of distinct signals. ASK modulation refers to a modulation scheme in which digital data is represented as binary variations in the amplitude of a carrier wave.

In ASK-based communication, the transmitting device 110 generates a carrier signal. The carrier signal is typically a sinusoidal wave produced by filtering a PWM-generated square wave. The digital information to be transmitted can be associated with the modulation of the amplitude of the carrier signal.

In embodiments, the PWM timer circuit 304 embedded within the microcontroller 302 generates a PWM square wave based on programmed parameters. Microcontroller 302 can precisely control the square wave's frequency, duty cycle, and timing.

In embodiments, PWM timer circuit 304 can employ frequency dithering by slightly varying the signal frequency according to a predetermined pattern stored in a dithering table. The potentially dithered PWM signal is sent to the transmitter coil, generating an electromagnetic field for power transfer and data communication. The approach allows for simultaneous power transfer and data transmission, with the data essentially riding on the power transfer signal.

After PWM timer circuit 304 generates the digital square wave, it is passed through additional circuitry 306, such as a power inverter and a filter, to create a sinusoidal wave used in the inductive power transfer process. The receiving device 120 rectifies the induced signal at the receiver coil 122, which charges the receiving device 120. In embodiments, the resonant filtering is performed by a capacitor and the transmitter coil 112.

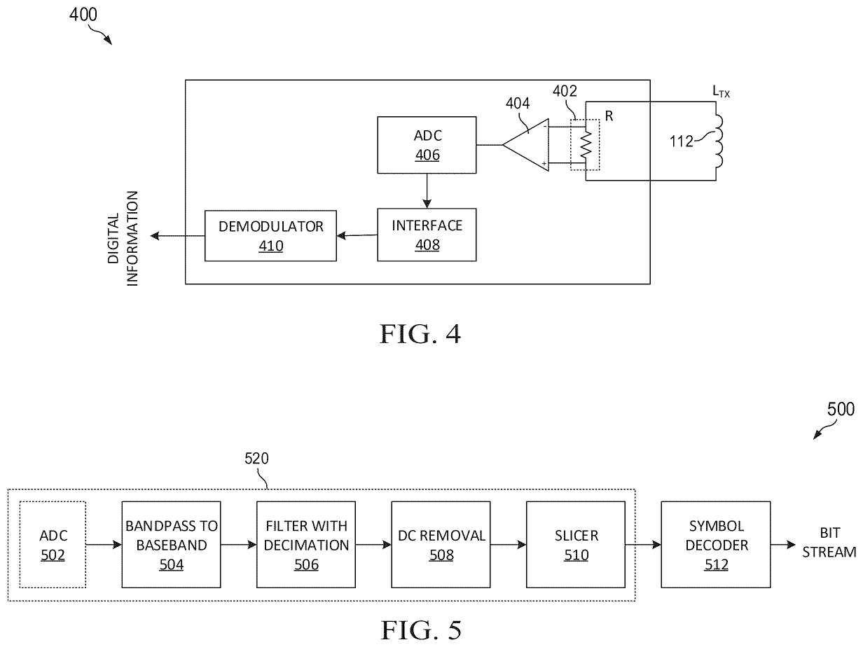

FIG. 4 illustrates a schematic of an embodiment sensing circuit 400, which may be in transmitting device 110 for backscatter modulation detection. Sensing circuit 400 is coupled to the terminals of the transmitter coil 112. Sensing circuit 400 includes a sense resistor (R) 402, an amplifier 404, an analog-to-digital converter (ADC) 406, an interface 408, and a demodulator circuit 410, which may (or may not) be arranged as shown. Sensing circuit 400 may include additional components that are not shown.

When the receiving device 120 modulates its load 128 (for example, by changing its impedance), this causes detectable changes in the current or voltage of the transmitter coil 112. Sensing circuit 400 continuously monitors the characteristics of the transmitter coil 112, such as current or voltage.

The sense resistor 402 detects the variations through the transmitter coil 112. The voltage across the sense resistor 402 is proportional to the coil current. The amplifier 404 amplifies the voltage across the sense resistor 402 and feeds it into the ADC 406.

ADC 406 converts the amplified analog voltage across the sense resistor 402 to a digital signal. In embodiments, ADC 406 is coupled to the demodulator circuit 410 through the interface 408. In embodiments, interface 408 involves a serial data interface and a pre-conditioning digital signal processing unit, responsible for either removing residual DC components or band-pass filtering in the neighborhood of the ASK carrier frequency or windowing the incoming signal. In embodiments, interface 408 is direct or indirect, followed by offset removal and a resonant-like digital filter.

The digital signal from the ADC 406 is demodulated by the demodulator circuit 410. Demodulator circuit 410 analyzes the amplitude variations in the digital signal to extract the digital information sent by the receiving device 120.

FIG. 5 illustrates a circuit diagram of an embodiment demodulator circuit 500, which can be implemented as the demodulator circuit 410 in FIG. 4. The demodulator circuit 500 includes an analog-to-digital converter (ADC) 502, a bandpass-to-baseband converter 504, a filter with decimation 506, a DC removal high-pass filter (HPF) 508, an optional slicer circuit 510, and a symbol decoding circuit 512, which may (or may not) be arranged as shown. Demodulator circuit 500 may include additional components not shown.

The Amplitude Shift Keying (ASK) Digital Signal Processing (ASKD DSP) circuit 520 encompasses several components of the demodulator circuit 500, including the analog-to-digital converter (ADC) 502, bandpass-to-baseband converter 504, filter with decimation 506, and DC removal high-pass filter (HPF) 508. Collectively, these components perform the initial signal processing functions to extract the modulated information from the received ASK signal. The ASKD DSP circuit 520 processes the raw signal from the transmitter coil, converting it to a form suitable for subsequent stages of demodulation and decoding. Following the ASKD DSP circuit 520, the signal passes through the slicer circuit 510 and symbol decoding circuit 512 to produce the final bit stream output.

The analog-to-digital converter (ADC) 502 can be similar to the ADC 406 shown in FIG. 4. It acquires modulated samples from the primary coil of the transmitting device 110, which represents the backscatter modulated signal from the receiving device 120.

The bandpass-to-baseband converter 504 is a circuit that shifts the transmitted signal spectrum into the baseband domain, centering it around DC (i.e., 0 Hz). It effectively translates the frequency of the received signal from its carrier frequency down to baseband, where the information content of the signal is easier to extract.

The bandpass to baseband converter 504 can employ complex multiplication or quadrature mixing techniques. For example, it can multiply the incoming bandpass signal with a locally generated carrier signal that matches the frequency and phase of the received signal's carrier. The multiplication process results in sum and difference frequencies. The sum frequencies are typically filtered out, leaving the difference frequencies representing the original modulating signal centered around DC.

By shifting the signal to baseband, the bandpass to baseband converter 504 simplifies subsequent signal processing steps and reduces the computational requirements for the following stages of the demodulator circuit. The conversion can be particularly beneficial in ASK demodulation, allowing for easier amplitude detection and symbol recovery in the baseband domain.

As an image rejection filter, filter with decimation 506 removes high-frequency artifacts generated by the bandpass-to-baseband converter 504 during the downconversion process. The artifacts can include mixer products, harmonics, and other unwanted spectral components outside the desired baseband frequency range. By attenuating the high-frequency components, the filter with decimation 506 isolates the desired baseband signal and improves the overall signal-to-noise ratio. In embodiments, the filter with decimation 506 executes low-pass filtering and can perform notch filtering.

In addition to filtering, the filter with decimation 506 may incorporate decimation. Decimation involves reducing the signal's sampling rate, which can be done safely after low-pass filtering because the bandwidth requirements are decreased after downconversion. The decimation process typically involves discarding some samples or averaging groups of samples to produce a single output sample.

The decimation factor can be chosen based on the ratio between the ADC sampling rate and the desired output rate, which is often related to the symbol rate of the received signal. By reducing the sample rate, decimation helps to lower the computational requirements for subsequent processing stages and can improve the effective resolution of the signal.

Various digital filter structures can be used to implement the filter with decimation 506. Common approaches include finite impulse response (FIR) filters, infinite impulse response (IIR) filters, or cascaded integrator-comb (CIC) filters. The choice of filter structure depends on factors such as the required stopband attenuation, passband ripple, phase linearity, and computational efficiency.

The filter with decimation 506 helps condition the signal for subsequent processing stages, ensuring the baseband signal is clean and appropriately sampled for accurate demodulation.

The DC removal high-pass filter (HPF) 508 is coupled to the filter output with decimation 506. The DC removal high-pass filter (HPF) 508 is configured to remove the DC component that typically emerges during the downconversion process. During downconversion, a DC offset can be introduced into the signal due to, for example, local oscillator (LO) leakage, mixer imbalance, or a strong interferer. If left unaddressed, the DC offset can saturate subsequent demodulator stages, potentially leading to incorrect symbol decisions.

The DC removal high-pass filter (HPF) 508 is configured to attenuate very low-frequency components, effectively removing the DC offset while allowing higher-frequency components (which contain the desired signal information) to pass through. The cutoff frequency of the DC removal high-pass filter (HPF) 508 is typically set well below the lowest frequency of interest in the modulated signal but high enough to remove the DC component effectively.

In digital implementations, the DC removal high-pass filter (HPF) 508 can be realized using various filter structures. One common approach is to use a first-order Infinite Impulse Response (IIR) filter. Another approach is to use a Finite Impulse Response (FIR) filter designed with a high-pass response. FIR filters offer linear phase response and stability advantages but may require more computational resources than IIR filters.

For systems dealing with I and Q channels (or M and P in polar coordinates), separate high-pass filters can be employed for each channel to ensure proper DC removal across all signal components.

The DC removal high-pass filter (HPF) 508 may incorporate adaptive techniques for varying DC offsets. The adaptive filters can adjust their parameters in real-time based on the input signal characteristics, providing more robust DC removal across different operating conditions.

In wireless power transfer systems, effective DC removal maintains the integrity of the modulated signal. By removing the DC component, the DC removal high-pass filter (HPF) 508 helps center the signal around zero, facilitating more accurate symbol detection in subsequent demodulator stages.

Slicer circuit 510 is coupled to the output of the DC removal high-pass filter (HPF) 508. It helps clean up the received signal, which may have been affected by noise and distortions during transmission.

Due to the previous DC removal stage, slicer circuit 510 accepts a typically symmetric signal around zero. Slicer circuit 510 performs a binary decision based on a threshold parameter or a pair of thresholds when a hysteresis mechanism is employed. The threshold determines the decision boundary between the two output states, affecting how the incoming signal is interpreted as binary data.

The process creates a two-level (binary) output signal, representable on one or more bits. Slicer circuit 510 is substantially a hysteresis comparator. Slicer circuit 510 compares the incoming signal level to two opposite thresholds. If the signal level is above the positive threshold, the slicer outputs one binary state (e.g., a logical ‘1’). If the signal level is below the negative threshold, it outputs the other binary state (e.g., a logical ‘0’).

Slicer circuit 510 prepares the signal for subsequent symbol decoding by compressing the information into a binary output with two opposite values. The compression simplifies the data stream while preserving the essential information encoded in the signal's amplitude variations.

The symbol decoding circuit 512 is coupled to the output of slicer circuit 510. It interprets the binary stream to extract meaningful data according to the communication protocol used in the wireless power transfer system. In the context of wireless power transfer systems that are compliant with the Qi standard, the symbol decoding circuit 512 is designed to handle bi-phase mark coding. This coding scheme is synchronized with a clock signal with a frequency of 2 kHz±4%, which also corresponds to the bit rate of the communication.

The bi-phase mark coding used in Qi-compliant systems has specific characteristics recognized by the symbol decoding circuit 512. There is a systematic edge at the beginning of each clock period. The absence of an intermediate transition within the bit period represents a ‘0’ bit. A ‘1’ bit is represented by a transition at the mid-point of the bit period.

To decode the information, the symbol decoding circuit 512 may employ edge detection mechanisms to identify the transitions in the binary stream from slicer circuit 510. By analyzing the presence or absence of these mid-bit transitions, the symbol decoding circuit 512 can determine whether each bit period contains a ‘0’ or a ‘1’.

In embodiments, the symbol decoding circuit 512 handles the message structure defined by the Qi standard. Typically, a message begins with a preamble consisting of a sequence of consecutive ‘1’ bits. The number of preamble bits is not fixed, and the choice of a specific preamble length may depend on various factors. In particular, according to the Qi standard, it can range from eleven to twenty-five bits. After the preamble, the symbol decoding circuits 512 identifies a start bit (always ‘0’), one data byte (8 bits of actual information), a parity bit (set to ‘1’ if the data byte contains an even number of ‘1’bits), and a stop bit (always ‘1’).

Following the processing by the slicer circuit 510, the symbol decoding circuit 512 interprets the binary stream to extract meaningful data according to the communication protocol used in the wireless power transfer system. The symbol decoding circuit 512 can implement various decoding approaches to process the ASK modulated signals with biphase-mark coding.

In embodiments, the symbol decoding circuit 512 may incorporate state machines or sequence detectors to track the progression through the message components. This allows the symbol decoding circuit 512 to frame the incoming data and extract the relevant information bits. The symbol decoding circuit 512 may also include error detection mechanisms. For instance, it can verify the parity bit to ensure the integrity of the received data byte. If a parity error is detected, it may flag the data as potentially corrupted.

In embodiments, an interval-based decoding mechanism may be employed, where the time intervals between biphase-mark coding (BMC) edges are analyzed after direct measurements or in terms of a metric associated with them. In this method, the sequence of intervals allows for determining bit values. For example, two consecutive short intervals can represent a binary ‘1’ while one long interval can represent a binary ‘0’. The decoder measures the duration between detected edges in the signal and compares these durations to expected values for half-bit and full-bit intervals. This approach leverages the temporal characteristics of the biphase-mark coding to distinguish between different bit values.

In some embodiments, a similarity score mechanism may be employed. This method can consist of checking the highest response among matched filters, each associated with a possible combination of the last N bits. For example, with N equal to three, the system can employ eight matched filters corresponding to all possible three-bit combinations (‘000’, ‘001’, ‘010’, ‘011’, ‘100’, ‘101’, ‘110’, and ‘111’). The incoming signal can be compared against each of these filter patterns, and the filter producing the highest response in absolute value can be used to indicate the most likely bit sequence. This technique effectively implements a pattern recognition approach to decoding, identifying the most probable bit sequence based on signal correlation with known patterns. Symbol decoding circuit 512 may need to adapt its decoding strategy based on the incoming demodulated signal (e.g., switching between different decoding algorithms).

The output of the symbol decoding circuit 512 is typically a stream of decoded data bits, representing the information transmitted from the receiving device 120 to the transmitting device 110. The message data may include information about power requirements, device identification, or other control signals relevant to the wireless

### Power Transfer Process.

The demodulator circuit 500 processes the received signal through these stages to extract the digital information sent by the receiving device 120. The arrangement allows for flexible handling of the ASK modulation, addressing challenges posed by a potential spurious phase modulation in specific frequency ranges of wireless power transfer systems.

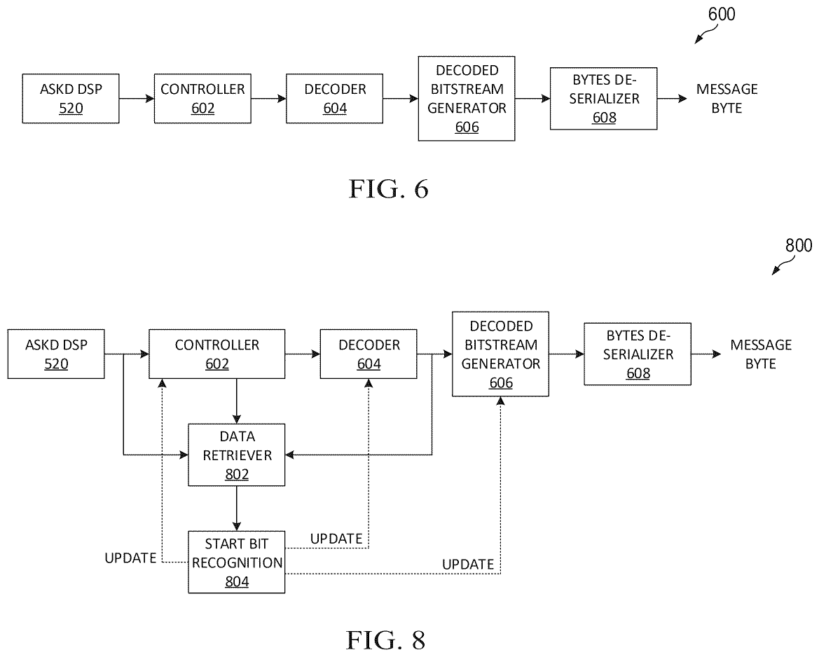

FIG. 6 illustrates a block diagram of an embodiment decoder circuit 600 for processing ASK modulated signals in wireless power transfer systems. The decoder circuit 600 includes an ASKD DSP circuit 520, a controller 602, a decoder 604, a decoded bitstream generator 606, and a bytes de-serializer 608, which may (or may not) be arranged as shown. The ASKD DSP circuit 520 may be implemented as the ASKD DSP circuit 520 shown in FIG. 5, performing the initial signal processing functions necessary for demodulation.

In embodiments, controller 602 is a controller of samples for the decoder, positioned between the ASKD DSP circuit 520 and the decoder 604. Controller 602 is configured to propagate the appropriate samples to decoder 604. Controller 602 may implement various conditioning functions depending on the specific decoding mechanism to prepare the signal for optimal decoding.

The decoder 604 receives the conditioned samples from controller 602 and performs the decoding operations to extract the digital information from the ASK-modulated signal—the decoder 604 provides single decoded bits as output. The decoder 604 processes these samples according to the implemented decoding algorithm, which may vary based on system requirements and signal characteristics.

The decoded bitstream generator 606 receives the output from the decoder 604 and generates one or more bitstreams depending on the decoding mechanism. In some embodiments, the decoded bitstream generator 606 may correspond to a single wire propagating the decoder output. The decoded bitstream generator 606 output constitutes the decoded bitstream or bitstreams containing the extracted digital information.

The bytes de-serializer 608 receives the decoded bitstream or bitstreams from the decoded bitstream generator 606 and groups the bits into bytes according to the bit transmission mechanism of the Qi standard, which follows a UART-like protocol. To ensure data integrity, the bytes de-serializer 608 can perform error checks on the received data, such as parity verification. The output of the bytes de-serializer 608 is the message byte, which contains the information transmitted from the power receiver to the power transmitter.

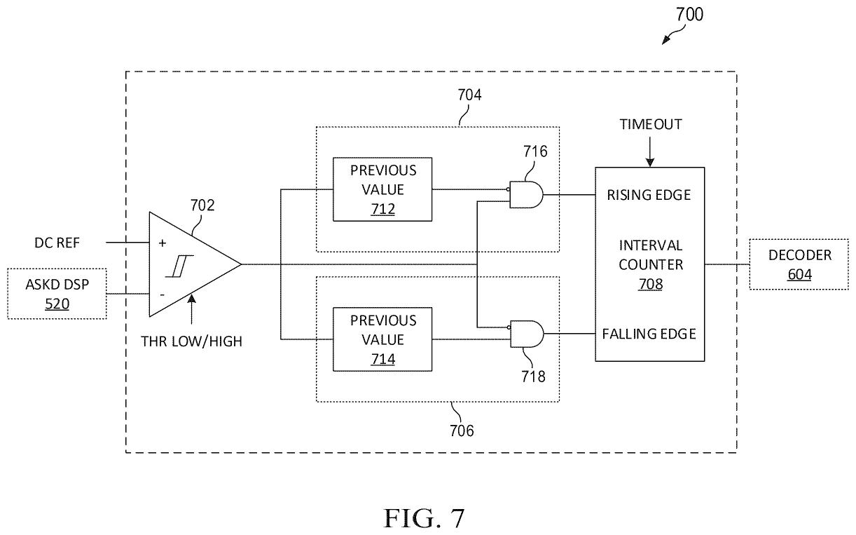

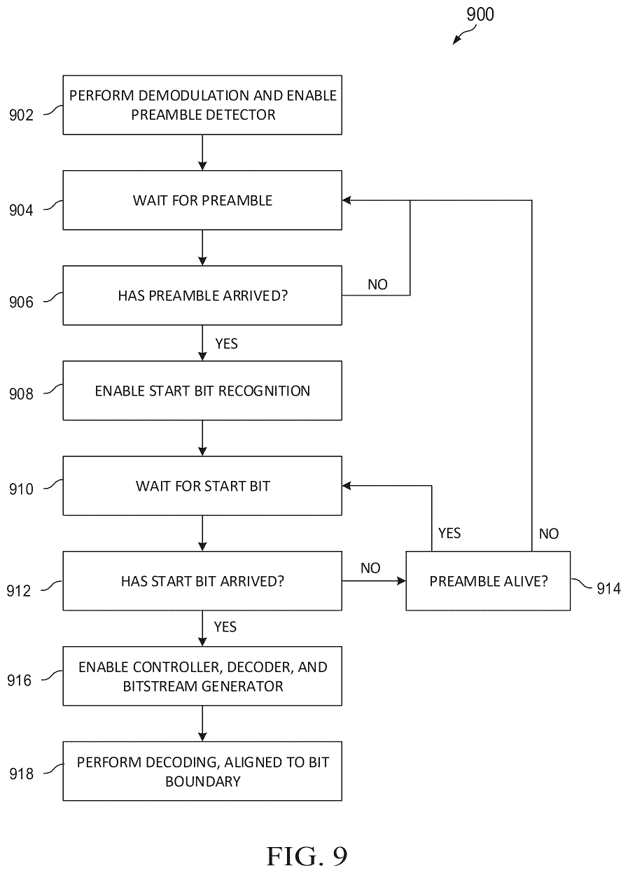

FIG. 7 illustrates an embodiment controller circuit 700, which can be implemented as the controller 602 shown in FIG. 6. The controller circuit 700 is designed for interval-based decoding. It includes a comparator 702, a rising edge detector circuit 704, a falling edge detector circuit 706, and an interval counter 708, which may (or may not) be arranged as shown.

The controller circuit 700 receives input from the ASKD DSP circuit 520 and a DC reference signal. The comparator 702 compares these inputs against configurable threshold levels (THR LOW/HIGH), expected in the neighborhood of the DC reference, to generate a binary output signal that transitions between high and low states based on the ASK modulated signal's amplitude. This binary signal forms the basis for edge

### Detection and Interval Measurement.

The rising edge detector circuit 704 includes a previous value register 712 and a logic gate 716. The previous value register 712 stores the previous state of the comparator output, while the logic gate 716 compares this stored value with the current comparator output to detect rising edges in the signal. When a rising edge is detected, the circuit generates a rising edge signal sent to the interval counter 708.

Similarly, the falling edge detector circuit 706 includes a previous value register 714 and a logic gate 718. This circuit operates analogously to the rising edge detector but is configured to identify falling edges in the comparator output. When a falling edge is detected, the circuit generates a falling edge signal that is also sent to the interval counter 708. It can also be highlighted that the previous value registers 712 and 714 can be merged in a unique previous value register.

The interval counter 708 measures the time intervals between detected edges in terms of the number of samples. When an edge (rising or falling) is detected, the interval counter 708 outputs its current count value to the decoder 604 and resets to begin counting for the next interval. The counter may also include a timeout mechanism to handle situations where no edges are detected for an extended period.

This interval-based approach allows the controller circuit 700 to measure the durations between signal transitions, which directly correspond to the encoded bit values in biphase-mark coding. In this coding scheme, two consecutive short intervals represent a binary ‘1’, while one long interval represents a binary ‘0’. By accurately measuring these intervals, with a resolution, the controller circuit 700 provides the decoder with the necessary information to determine the transmitted bit values.

The controller circuit 700 represents one of several possible implementations for the controller of samples for the decoder. Other implementations may include a simple wire bypass for direct signal propagation, conditioning circuits such as signal amplifiers or matched filters, or sample decimators that may incorporate conditioning circuits. The specific implementation depends on the decoding approach and system requirements for the wireless power transfer application.

Biphase-mark coding does not define a specific sequence to be respected by the “positive” and “negative” binary ones and zeros, and the preamble consists of a sequence of binary ones. These characteristics introduce ambiguity in recognizing the bit boundary during demodulation and decoding.

Even though the number of short intervals during the preamble is even by definition (as each binary one corresponds to two short intervals), it is not guaranteed that an even number of short intervals will be detected on the receiver side. This issue can occur when a comparator centered around zero is employed. Due to the initial transient of the filter, the demodulated signal may still have a DC component that prevents the comparator from toggling since the first modulation.

These misunderstandings affect the decoding process, which may become aligned to the half-bit position instead of the beginning of the bit. This misalignment can create challenges for accurate data recovery from the ASK modulated signal.

The start bit, always equal to binary zero, can be exploited to remove these ambiguities and ensure the decoder's proper alignment to the actual bit boundaries.

A different approach addresses the bit boundary ambiguity problem in conventional ASK demodulation systems. The controller of samples for decoder 604 enables the decoder 604 every half-bit interval—at the bit boundary and at the half-bit position—to ensure that decoding is performed at the correct bit boundary. This approach is feasible because the nominal bit duration is defined by the Qi standard, making it possible to predict the timing of half-bit intervals.

In these conventional systems, the decoded bitstream generator determines the correct bitstream by analyzing the decoder outputs and exploiting the Qi-standard UART-like data formatting rules. These rules specify that a message begins with a start bit (always binary zero), followed by a data byte, a parity bit, and a stop bit (always binary one). By examining potential bitstreams (one aligned to the bit boundary and one aligned to the half-bit), the system can identify which one conforms to the expected message format.

In conventional systems, the half-bit-periodicity synchronization is typically assisted by a Phase-Locked Loop (PLL), which helps maintain accurate timing for the half-bit interval sampling. This approach is commonly employed with similarity-score-based decoders, where pattern matching is used to identify the most likely bit sequences.

However, this conventional method has significant drawbacks. Although it can effectively remove ambiguity by performing decoding procedures at potential bit boundaries, it is considerably power-hungry. The decoder must operate twice as frequently—once at each half-bit interval—consuming more power than necessary. This increased power consumption can be particularly problematic in battery-powered devices or applications where energy efficiency is prioritized.

FIG. 8 illustrates an embodiment decoder circuit 800 for start bit recognition in wireless power transfer communication systems. The decoder circuit 800 includes the ASKD DSP circuit 520, the controller 602, the decoder 604, the decoded bitstream generator 606, the bytes de-serializer 608, a data retriever circuit 802, and a start bit recognition circuit 804, which may (or may not) be arranged as shown.

The decoder circuit 800 addresses the challenge of bit boundary ambiguity in biphase-mark coding by implementing hardware detection of the start bit (the first binary zero following the preamble) and using this information to ensure proper alignment of the decoder to the actual bit boundaries. This approach eliminates the uncertainty between bit boundary and half-bit boundary that can occur during ASK demodulation.

The data retriever circuit 802 acquires information from the ASKD DSP circuit 520, the controller 602, and the decoder 604. Depending on the decoding mechanism employed, the data retriever circuit 802 collects different signals and data from these blocks. After processing this information, the data retriever circuit 802 provides appropriate data and control signals to the start bit recognition circuit 804.

The start bit recognition circuit 804 analyzes the information from the data retriever circuit 802 to identify the first bit following the preamble sequence. Once the start bit is detected, the start bit recognition circuit 804 sends update signals to controller 602, decoder 604, and decoded bitstream generator 606, ensuring that all components are properly synchronized to the correct bit boundaries.

The update mechanism allows the decoder circuit 800 to align the decoding process precisely at the beginning of each bit rather than at half-bit positions. This alignment is critical for accurately interpreting the biphase-mark coded signals, as misalignment can lead to incorrect bit value determinations and subsequent data errors.

By leveraging the known characteristics of the start bit (always a binary zero), the decoder circuit 800 provides a robust solution to the bit boundary ambiguity problem that can occur in ASK communication for wireless power transfer systems. This approach enhances the reliability of the communication link between the power receiver and power transmitter without requiring the more power-intensive methods used in conventional systems.

Compared to conventional approaches that typically operate with only two samples per bit interval and rely on statistical similarity evaluations, embodiments of the disclosure can utilize more than two samples per bit interval and employ direct threshold-based detection methods. This approach eliminates the need for mandatory phase alignment circuits and complex pattern-matching algorithms, resulting in more efficient implementation and improved robustness against alignment issues. The threshold-based detection methods described herein maintain consistent detection parameters throughout the decoding process, simplifying implementation while enhancing reliability across varying operating conditions.

Further, the approaches described in this disclosure scale effectively with different sampling rates, making them adaptable to various system requirements and hardware capabilities. As the sampling rate increases, providing more samples per bit interval, the detection performance typically improves without requiring changes to the fundamental detection algorithm. This scalability allows implementers to make appropriate trade-offs between detection performance and computational resources based on their specific application needs. In resource-constrained environments, the system can operate with fewer samples per bit while still maintaining acceptable performance; in applications where detection reliability is paramount, the sampling rate can be increased to enhance performance without architectural changes to the detection system. This flexibility represents a significant advantage over conventional approaches often optimized for specific sampling rates and may require substantial redesign when system parameters change.

Advantageously, decoder circuit 800 offers improvements in resource utilization and power consumption compared to conventional solutions. Implementing the start bit recognition approach eliminates the need to perform decoding operations twice per bit interval, as is required in conventional systems that enable the decoder at both bit boundaries and half-bit positions.

This reduction in decoding frequency directly translates to lower power consumption, as the decoder 604 and associated processing circuits are activated only when necessary—once per bit interval after proper alignment is established. This power efficiency can extend the operating time and reduce thermal management requirements for battery-powered devices such as mobile phones, tablets, and wearables that utilize wireless charging as power receivers and power transmitters.

Additionally, the decoder circuit 800 optimizes resource utilization by leveraging the communication protocol's inherent characteristics. Rather than employing complex Phase-Locked Loop (PLL) circuits to maintain half-bit interval timing, the system uses the start bit's known value (binary zero) as a natural synchronization point. This approach reduces hardware complexity while improving reliability.

The data retriever circuit 802 and start bit recognition circuit 804 can be implemented with relatively simple digital logic compared to the more complex synchronization circuits required in conventional systems. Once the start bit is detected and proper alignment is established, the system maintains synchronization throughout the message reception, eliminating the need for continuous re-synchronization efforts that consume additional power.

The decoder circuit 800 can provide an optimal balance between performance and efficiency in wireless power transfer systems where communication may be intermittent. The power savings become particularly significant during extended charging sessions, where numerous control and status messages may be exchanged between the power transmitter and receiver.

In embodiments, the data retriever circuit 802 can be implemented as a preamble detector, enabling the start bit recognition circuit 804 after recognizing the preamble sequence. This implementation creates a hierarchical detection approach where the preamble is first identified, followed by the start bit, ensuring proper sequence recognition and timing.

When functioning as a preamble detector, the data retriever circuit 802 monitors the output from the ASKD DSP circuit 520 or the output from the controller 602 (in particular, for distance-based decoding scenarios) for patterns consistent with the consecutive binary ones constituting a preamble in Qi-standard communications. Upon detecting a valid preamble sequence, it activates the start bit recognition circuit 804 to search for the first binary zero that marks the start bit.

The enable operation initiated by the data retriever circuit 802 can refer to the simple enabling of data processing and the activation of circuits from a low-power rest mode. This flexibility allows the system to optimize power consumption based on the wireless power transfer application's specific implementation and power management requirements.

An example of a preamble detector circuit is discussed in U.S. patent application Ser. No. 18/962,539, titled “Preamble Detection for Wireless Power ASK Communication,” owned by the same assignee, which is hereby incorporated by reference herein in its entirety. The embodiments presented in U.S. patent application Ser. No. 18/962,539 can be applied to implement the preamble detector functionality of the data retriever circuit 802. This can include various correlation techniques, threshold detection methods, and decision logic approaches to provide robust preamble detection in ASK communication systems.

In embodiments, while the start bit recognition circuit 804 is monitoring for the start bit, the data retriever circuit 802 continues to verify that the preamble sequence is still being received. Because the preamble may be interrupted or a false preamble detection may occur, which could lead to incorrect start bit detection and subsequent decoding errors, the verification step can be advantageous.

If the data retriever circuit 802 determines that the preamble sequence is no longer being received before the start bit is detected, the system can return to the preamble detection state. This approach ensures that the system does not attempt to detect a start bit when a valid preamble is not present, preventing potential misalignment of the decoder to incorrect bit boundaries.

Unlike conventional systems that typically operate with only two samples per bit interval, embodiments of the disclosure can utilize more than two samples per bit interval, providing enhanced robustness against alignment issues between modulation edges and the decimator.

The start bit recognition approaches described herein differ fundamentally from conventional statistical or sequence matching methods. Rather than performing complex similarity evaluations through minima searches within moving observation windows, the disclosed approaches utilize direct threshold detection on demodulated samples, not involving any other reference signal associated with the bits to be decoded. The comb filter method and the moving average method exploit crossings of programmable thresholds that remain constant throughout the entire decoding process. This approach offers significant advantages in terms of implementation simplicity and computational efficiency

FIG. 9 illustrates a flowchart of an embodiment method 900 for operating the decoder circuit 800 in wireless power transfer communication systems. Method 900 provides a systematic approach to detecting the preamble, recognizing the start bit, and aligning the decoding process to the correct bit boundaries. In various embodiments, the method may include additional or fewer steps, or the steps may be performed differently than illustrated.

At step 902, the system starts demodulating the ASK-modulated signal and enables the data retriever circuit 802 (e.g., a preamble detector). This initial step activates the signal processing chain and prepares the system to monitor for incoming communication. In embodiments, the enable operation can refer to the simple enabling of processing data and activating circuits from a low-power rest mode, allowing for flexible power management strategies.

At step 904, the system waits, monitoring the demodulated signal for patterns consistent with a preamble sequence. During this waiting period, the system continues to process the incoming signal while conserving power by maintaining other components in a low-power state.

At decision step 906, the system determines whether a preamble has been detected. If no preamble is detected (NO path), the process returns to step 904 to continue waiting. If a preamble is detected (YES path), the process advances to step 908.

At step 908, the system enables the start bit recognition circuit 804, which begins monitoring for the first binary zero following the preamble sequence. This step transitions the system from preamble detection to start bit detection, focusing the processing resources on identifying the synchronization point.

At step 910, the system waits for the start bit while continuing to monitor the incoming signal. This waiting state is employed to identify the transition from the preamble's consecutive binary ones to the binary zero that constitutes the start bit.

At decision step 912, the system determines whether the start bit has arrived. If the start bit has not been detected (NO path), the process moves to decision step 914 to check if the preamble is still present. If the start bit has been detected (YES path), the process advances to step 916.

At decision step 914, the system verifies whether the preamble is still being received. This check ensures that the system hasn't missed the start bit or encountered a false preamble detection. If the preamble is still present (YES path), the process returns to step 910 to continue waiting for the start bit. If the preamble is no longer present (NO path), the process returns to step 904 to resume waiting for a new preamble, effectively resetting the detection sequence.

At step 916, the system enables the controller 602, decoder 604, and bitstream generator 606 once the start bit has been successfully detected. This step activates the components for processing and reconstructing the data portion of the message, with all circuits now properly synchronized to the correct bit boundaries.

Finally, at step 918, the system performs decoding operations aligned to the bit boundary, ensuring accurate interpretation of the biphase-mark coded signal. With proper alignment established through the start bit recognition, the system can reliably decode the subsequent data bits, parity bit, and stop bit that make up the complete message.

In various embodiments, the method may include additional or fewer steps, or the steps may be performed differently than illustrated.

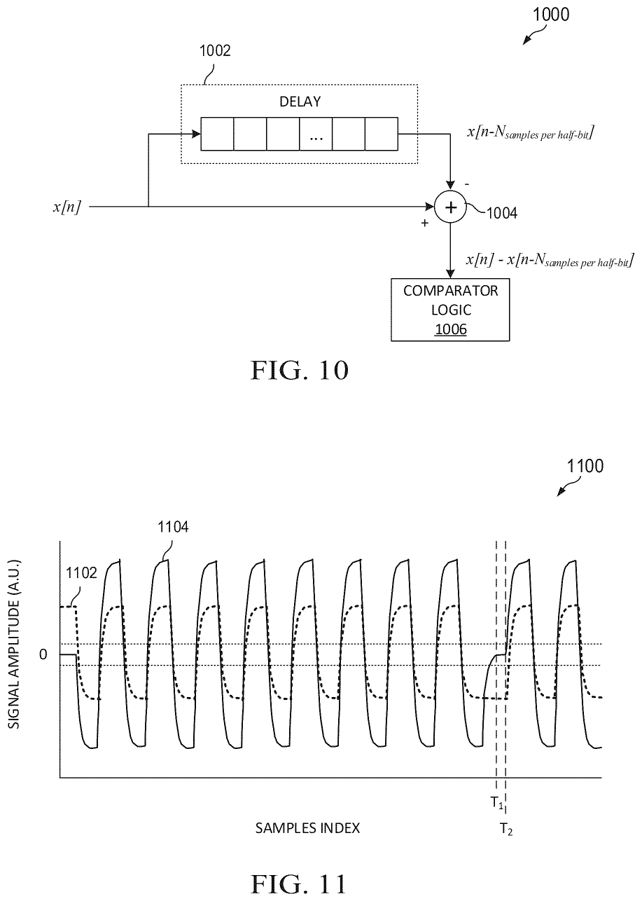

FIG. 10 illustrates an embodiment start bit recognition circuit 1000, which can correspond to the start bit recognition circuit 804 shown in FIG. 8. The start bit recognition circuit 1000 employs a comb filter approach to identify the start bit in ASK-modulated signals. The circuit includes a delay element 1002, a subtractor 1004, and a comparator logic 1006, which may (or may not) be arranged as shown.

The comb filter approach implemented in the start bit recognition circuit 1000 provides an efficient method for distinguishing between the preamble bits (binary ones) and the start bit (binary zero) in ASK modulated signals, enabling reliable synchronization of the decoding process to the correct bit boundaries.

The delay element 1002 receives the input signal x[n] and delays it by a specific number of samples corresponding to half a bit interval (i.e., N_{samples per half-bit}, whose value depends on the bit rate and the sampling frequency associated with the discrete-time signal x[n]). This delayed signal x[n−N_{samples per half-bit}] is provided to the subtractor 1004. The subtractor 1004 continuously calculates the difference between the current sample x[n] and the delayed sample x[n−N_{samples per half-bit}] , effectively implementing a comb filter operation.

The output of the subtractor 1004, represented as x[n−N_{samples per half-bit}] , is fed into the comparator logic 1006. The comparator logic 1006 analyzes this difference signal to determine when the start bit has been detected. During preamble bits (binary ones), the absolute value of the difference will be significantly greater than zero due to the transitions in the biphase-mark coded signal. However, when the start bit (binary zero) is encountered, the difference approaches zero for a duration equal to the half-bit interval, as the signal maintains a more consistent level.

An advantage of this comb filter approach is its effectiveness with any number of samples per bit interval, not just the two samples typically used in prior art systems. While conventional approaches often limit processing to exactly two samples per bit period (one at the bit boundary and one at the half-bit position), the comb filter implementation can leverage multiple samples throughout the bit interval. This flexibility allows the system to maintain robust detection performance even when the sampling rate varies or the modulation edges are not perfectly aligned with the sampling instances. With more samples per bit interval, the comb filter can more accurately characterize the signal transitions during preamble bits and the relative stability during the start bit, providing more reliable detection even in challenging signal conditions. This adaptability eliminates the need for precise phase alignment circuits that are commonly required in two-sample systems.

FIG. 11 illustrates an example waveform diagram 1100 depicting the operation of the start bit recognition circuit 1000. The diagram shows signal amplitude plotted against samples index, with two waveforms: the demodulated ASK signal 1102 and the comb filter output signal 1104 (i.e., the difference signal from subtractor 1004).

During the preamble sequence (e.g., before time T₁), the demodulated ASK signal 1102 and the output of the comb filter output signal 1104 exhibit regular oscillations with significant amplitude. The demodulated ASK signal 1102 shows the characteristic pattern of biphase-mark coded binary ones, while the comb filter output signal 1104 shows corresponding variations as it calculates the difference between current and half-bit delayed samples.

Changes occur in both waveforms at time T₁, when a start bit is occurring. The demodulated ASK signal 1102 transitions to a pattern consistent with a binary zero (the start bit), and correspondingly, the comb filter output signal 1104 approaches zero and stays close to zero for an entire half-bit interval starting at time T₁ and ending when the following bit boundary occurs at time T₂. This near-zero condition in the comb filter output indicates the presence of the start bit.

During operation, the comparator logic 1006 monitors the comb filter output or its absolute value and checks if it falls below a user-defined threshold (near zero) for a user-defined number of consecutive samples. This approach provides robustness against duty-cycle variations that may deviate from the ideal 50%. Unlike conventional methods that rely on complex pattern matching algorithms, this threshold-based approach maintains consistent detection parameters throughout the decoding process, simplifying implementation while improving reliability.

In operation, the comparator logic 1006 monitors the absolute value of the comb filter output and checks if it falls below a user-defined threshold (near zero) for a user-defined number of consecutive samples. This approach provides robustness against duty-cycle variations that may deviate from the ideal 50%. The circuit determines that the start bit has been detected when the threshold condition is met for the specified number of consecutive samples.

Following the detection of the start bit, the next modulation edge in the signal is identified as the beginning of the first data bit. Identifying the bit boundary allows the decoder to align its operations correctly, ensuring accurate interpretation of the subsequent data bits in the message.

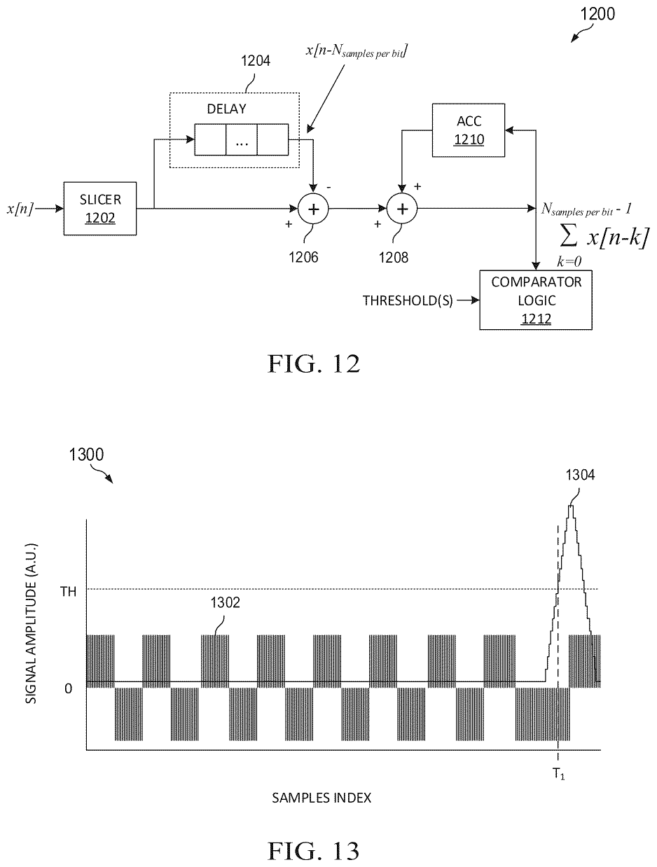

FIG. 12 illustrates an embodiment start bit recognition circuit 1200, which can be implemented as the start bit recognition circuit 804 shown in FIG. 8. The start bit recognition circuit 1200 employs a moving sum filter approach to identify the start bit in ASK modulated signals. The circuit includes an optional slicer 1202, a delay element 1204, a subtractor 1206, an adder 1208, an accumulator (ACC) 1210, and comparator logic 1212, which may (or may not) be arranged as shown.

This approach provides an efficient and reliable method for distinguishing the start bit from the preamble bits in ASK modulated signals, enabling proper synchronization of the decoding process.

The slicer 1202 receives the input signal x[n] and normalizes it to produce a binary output that can assume two values (the same value) with opposite signs. This normalization helps filter out unwanted noise through the slicer's threshold mechanism. The normalized signal is fed directly to the subtractor 1206 and passed through the delay element 1204.

The delay element 1204 delays the slicer output by a specific number of samples corresponding to a bit interval (i.e., N_{samples per bit}, whose value depends on the bit rate and the sampling frequency associated with the discrete-time signal x[n]). The delayed signal x[n−N_{samples per bit}] is provided to the subtractor 1206, which calculates the difference between the current and delayed samples.

The output of the subtractor 1206 is fed into the adder 1208, which combines it with the feedback from the accumulator 1210. The accumulator 1210 stores the running sum, implementing an integration process that enhances the detection capability by accumulating the signal over multiple samples. The output of the adder 1208 is fed back to the accumulator 1210 and forwarded to the comparator logic 1212.

The output signal provided to the comparator logic 1212 represents the summation of x[n−k] from k=0 to N_{samples per bit}−1. This summation effectively implements a moving sum filter over a complete bit interval, corresponding to a matched filter for a biphase-mark coded binary zero.

The comparator logic 1212 analyzes the accumulated moving sum to determine when it exceeds a user-programmable positive threshold (TH) or its opposite negative threshold (−TH). When the threshold is exceeded, the circuit identifies the presence of the start bit.

In embodiments, the comparator logic 1212 analyzes the absolute value of the accumulated moving sum to determine when it exceeds a user-programmable threshold (TH). When the threshold is exceeded, the circuit identifies the presence of the start bit.

In embodiments, the threshold (TH) is configurable. In embodiments, the threshold (TH) is based on the slicer output characteristics and the number of samples per bit interval. In embodiments, the threshold (TH) is based on an estimated ASK amplitude estimated by, for example, an amplitude estimation circuit.

In embodiments, the function of the slicer 1202 may be performed by, for example, an amplitude estimation circuit to estimate an ASK amplitude. Accordingly, in some embodiments, the slicer 1202 may be replaced by an amplitude estimator circuit. The amplitude estimator circuit can detect maxima, minima, or both. In such embodiments, the input signal x[n] is fed to the amplitude estimator circuit, which detects the maxima, minima, or both of the input signal, and feeds the one or more values to comparator logic 1212.

FIG. 13 illustrates an example waveform diagram 1300 depicting the operation of the start bit recognition circuit 1200, with the absolute value on the moving sum output performed. The diagram shows signal amplitude plotted against samples index, with two waveforms: the slicer output 1302 and the absolute moving sum 1304 (scaled for visibility).

As shown, during the preamble sequence (e.g., before time T₁), the slicer output 1302 exhibits a regular alternating pattern between positive and negative values, characteristic of biphase-mark coded binary ones. The absolute moving sum 1304 remains relatively low during this period, as the matched filter for binary zero does not strongly correlate with the binary one pattern.

At time T₁, corresponding to detecting a start bit, the slicer output 1302 transitions to a pattern consistent with a binary zero (the start bit), and correspondingly, the absolute moving sum 1304 rises sharply, forming a distinctive peak that exceeds the threshold level (TH). This peak in the absolute moving sum indicates the detection of the start bit.

The moving sum filter approach is effective with more than two samples per bit interval. Unlike conventional systems with only two samples per bit (at bit boundaries and half-bit positions), this approach can accumulate evidence across multiple samples throughout the bit interval. As the number of samples increases, the moving sum accumulates more data points, resulting in a more pronounced peak when the start bit is detected and greater separation between the signal levels of binary ones and zeros.

This multi-sample capability provides enhanced robustness against timing jitter, sampling phase misalignment, and noise that might otherwise cause detection errors in systems limited to two samples per bit. The accumulation process effectively performs an integration operation over the bit interval, improving the signal-to-noise ratio compared to point-sample detection methods. Additionally, the moving sum approach maintains consistent performance across various sampling rates without requiring precise phase alignment circuits, offering implementation flexibility across different hardware platforms and operating conditions.

When the absolute value of the moving sum exceeds the user-programmable threshold or the moving sum goes outside the range delimited by the user-programmable thresholds, the comparator logic 1212 determines that the start bit has been detected. This direct threshold-based approach differs significantly from conventional methods that rely on statistical similarity measures or sequence matching. By utilizing a simple threshold comparison on accumulated samples, the circuit achieves reliable start bit detection without the computational complexity of pattern-matching algorithms or the need for additional phase alignment circuits.

When the absolute value of the moving sum exceeds the user-programmable threshold or the moving sum goes outside the range delimited by the user-programmable thresholds, the comparator logic 1212 determines that the start bit has been detected. Unlike the approach in FIG. 10, this method does not require a dedicated threshold for the number of consecutive samples satisfying the detection condition, as this requirement is implicitly addressed by the level threshold applied to the accumulated sum.

Following the detection of the start bit, the next modulation edge in the signal is identified as the beginning of the first data bit, allowing the decoder to align its operations correctly.

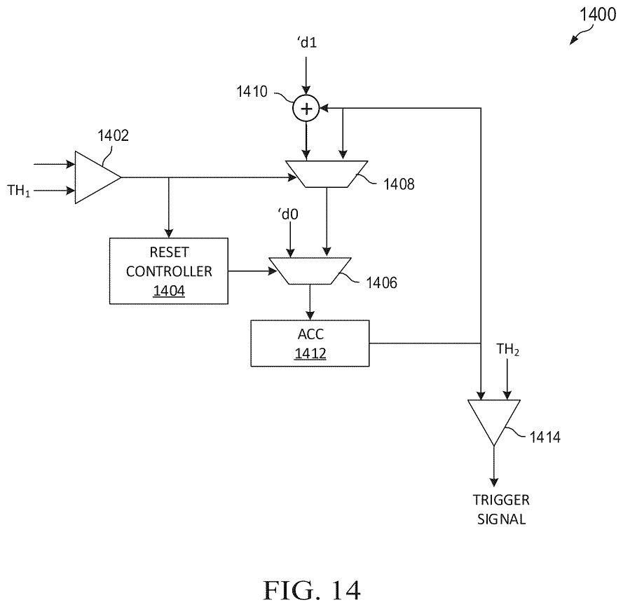

FIG. 14 illustrates a block diagram of an embodiment comparator circuit 1400, which can be implemented as the comparator logic 1006 of FIG. 10. The comparator circuit 1400 provides a unified architecture capable of handling multiple detection scenarios through different input configurations.

The embodiment comparator circuit 1400 includes a first comparator 1402, a first multiplexer 1406, an adder 1140, an accumulator (ACC) 1412, a second comparator 1414, a reset controller 1404, and a second multiplexer 1408, which may (or may not) be arranged as shown.

In embodiments, the first comparator 1402 can receive input directly from the subtractor 1004 or by an absolute value circuit following the subtractor 1004. In embodiments, a threshold range (using −TH₁ and +TH₁ as effective thresholds) is applied to the first comparator (when the input is not an absolute value). In embodiments, a first threshold value (TH₁) is applied to the first comparator 1402 (when the input is an absolute value). The threshold and the threshold range can be configured based on the input source.

The second multiplexer 1408 handles the increment value ('d1) and feedback path from the accumulator 1412. With the first multiplexer 1406, the data flow to the adder 1410 is controlled based on the comparison results from the first comparator 1402 and reset conditions from the reset controller 1404.

The reset controller 1404 manages the behavior of the first multiplexer 1406 based on the employed detection strategy. In the first mode, the reset controller 1404 resets the output of the first multiplexer 1406 when a sample falls below the first threshold value (TH₁). In an alternative mode, the reset controller 1404 forwards the output of the second multiplexer 1408 when samples fall below the first threshold value (TH₁), thus keeping the accumulator value and allowing the count to continue from its current value when new over-threshold samples arrive. In this mode, reset can be triggered by external events, such as timeout conditions occurring when no threshold crossings are detected for a predetermined number of consecutive input samples.

The accumulator 1412 maintains a count of qualified samples based on the output of the first comparator 1402 and the behavior of the reset controller 1404. The second comparator 1414 compares the accumulated count against a second threshold value (TH₂) to determine that the start bit has been detected for the specified number of consecutive samples. When the accumulated count meets or exceeds the second threshold value, the second comparator 1414 generates a trigger signal.

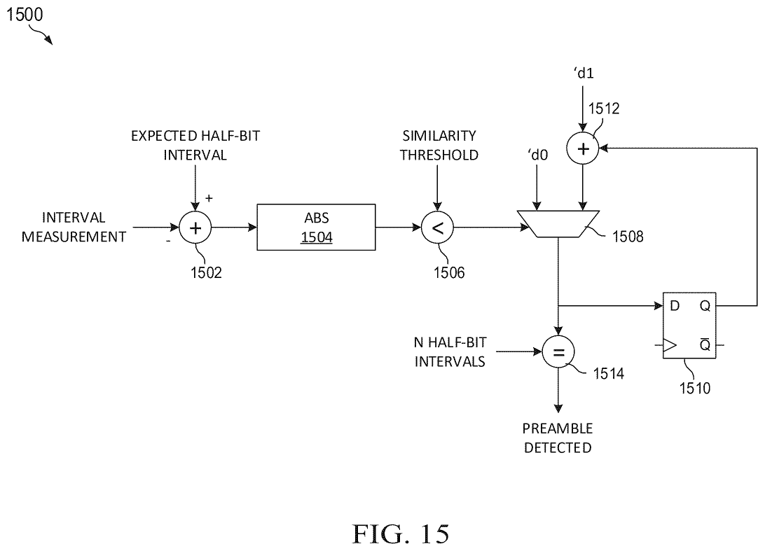

FIG. 15 illustrates a block diagram of an embodiment preamble detector circuit 1500, which can be implemented as the data retriever circuit 802 shown in FIG. 8. The preamble detector circuit 1500 is designed for interval-based decoding. It includes a subtractor 1502, an absolute value circuit (ABS) 1504, a comparator 1506, a multiplexer 1508, a register 1510, an adder 1512, and an equality comparator 1514, which may (or may not) be arranged as shown.

In embodiments, the preamble detector circuit 1500 continuously monitors the interval measurements, counting consecutive intervals compatible with half-bit durations. Once the required number of such intervals is detected, the preamble detector circuit 1500 enables the start bit recognition circuit, which then begins monitoring for the first interval compliant with a full-bit duration—indicating the presence of the start bit (binary zero).

This approach provides an efficient method for preamble detection in interval-based decoding systems. By focusing on the characteristic half-bit intervals present in the biphase-mark coded preamble (sequence of binary ones), the preamble detector circuit 1500 can reliably identify the beginning of a communication sequence and trigger the subsequent start bit recognition process at the appropriate time.

The preamble detector circuit 1500 receives interval measurement values from the controller of samples for the decoder, such as the controller circuit 700 shown in FIG. 7. These interval measurements represent the time between detected edges in the ASK modulated signal. The subtractor 1502 calculates the difference between the measured interval and an expected half-bit interval value. This difference is then processed by the absolute value circuit 1504, which outputs the magnitude of the deviation from the expected half-bit interval.

The output of the absolute value circuit 1504 is compared against a similarity threshold by the comparator 1506. When the absolute difference is less than the similarity threshold, the comparator 1506 outputs a signal indicating that the current interval corresponds to a half-bit duration. Based on the comparison result, this signal is fed to the multiplexer 1508, which selects between an increment value ('d1) and a reset value ('d0).

When the measured interval matches a half-bit duration, the multiplexer 1508 selects the increment value ('d1), which is then added to the current count stored in the register 1510 via the adder 1512. If the interval does not match a half-bit duration, the multiplexer 1508 selects the reset value ('d0), effectively resetting the counter. The register 1510 stores the running count of consecutive half-bit intervals detected, with its output fed back through the adder 1512 to implement the counting function.

The equality comparator 1514 receives the current count from the register 1510. It compares it against a predetermined value (i.e., the N half-bit intervals), representing the number of consecutive half-bit intervals that must be detected to confirm the presence of a valid preamble. When the count reaches this threshold value, the equality comparator 1514 generates a signal (i.e., preamble detected), indicating that a valid preamble sequence has been identified in the incoming ASK modulated signal.

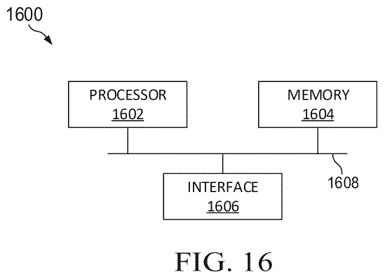

FIG. 16 illustrates a block diagram of an embodiment controller 1600 that can be used to implement the start bit detection for synchronizing decoders in wireless power transfer systems. The controller 1600 may execute the methods and implement the circuits described throughout this disclosure. The controller 1600 includes a processor 1602, a memory 1604, an interface 1606, and a bus 1608, which may (or may not) be arranged as shown. Controller 1600 may include additional components not shown.

Processor 1602 may comprise various types of processing hardware circuitry capable of executing instructions for start bit detection and decoder synchronization operations. It can be implemented as a microcontroller, a Digital Signal Processor (DSP), an Application-Specific Integrated Circuit (ASIC), a Field-Programmable Gate Array (FPGA), or combinations thereof. In some implementations, processor 1602 may include specialized circuits for demodulating ASK signals, detecting preamble sequences, recognizing start bits, and synchronizing decoders to the correct bit boundaries.

Memory 1604 may include non-transitory or transitory memory components. Non-transitory memory can include Read-Only Memory (ROM), Flash memory, or Electrically Erasable Programmable Read-Only Memory (EEPROM) for storing firmware or configuration parameters. Transitory memory can include Random Access Memory (RAM) such as Static RAM (SRAM) or other volatile memory types for temporary data storage during operation. Memory 1604 can store operational parameters for start bit detection and decoder synchronization, including threshold values, filter coefficients, and program instructions implementing the methods described in this disclosure.

Interface 1606 may facilitate communication with the wireless power transfer system components, allowing controller 1600 to process the demodulated ASK signals, detect preamble sequences, recognize start bits, and synchronize the decoding operations. Interface 1606 can include analog-to-digital converters for sampling signals, digital signal processing blocks for filtering and conditioning, and digital outputs for controlling the decoder circuits. The interface may also provide connectivity for external communications to enable configuration or monitoring of the wireless power transfer operations.

Bus 1608 provides a communication pathway between processor 1602, memory 1604, and interface 1606, enabling data transfer and coordination between these components during start bit detection and decoder synchronization operations. The bus 1608 may comprise multiple signal lines for transferring data, addresses, and control signals.

In embodiments, the controller 1600 implements the start bit detection methods by continuously monitoring the demodulated ASK signal, detecting preamble sequences, recognizing the start bit, and synchronizing the decoder to the correct bit boundaries.

It can be appreciated that controller 1600 may be integrated within the same integrated circuit as the wireless power transmitter circuitry or may be implemented as a separate component. In some embodiments, the functionality of controller 1600 may be distributed across multiple components or integrated with other power management functions to optimize overall system performance and efficiency.

A first aspect relates to a method for demodulating and decoding a signal in a wireless power transfer system, the method comprising detecting a preamble sequence by processing a demodulated signal corresponding to a demodulation of an amplitude shift keying (ASK) modulated signal, the preamble sequence comprising a series of consecutive binary ones encoded using biphase mark coding; monitoring for a start bit in response to detecting the preamble sequence, wherein the start bit comprises a binary zero following the preamble sequence; and performing decoding aligned to bit boundaries of subsequent data bits following the start bit.

In a first implementation form of the method, according to the first aspect as such, the method further comprising verifying, while monitoring for the start bit, that the preamble sequence continues to be received; and continue detecting the preamble sequence in response to the preamble sequence no longer being detected.

In a second implementation form of the method, according to the first aspect as such or any preceding implementation form of the first aspect, the method further comprising calculating a difference between a current sample of the demodulated signal and a sample delayed by half a bit interval, wherein detecting the start bit is in response to the difference being within a threshold range for a predetermined number of consecutive samples.

In a third implementation form of the method, according to the first aspect as such or any preceding implementation form of the first aspect, the method further comprising accumulating, by a moving sum filtering, samples of a demodulation-related waveform over a bit interval; and detecting the start bit in response to a result of the moving sum filtering being outside a threshold range.

In a fourth implementation form of the method, according to the first aspect as such or any preceding implementation form of the first aspect, the method further comprising extracting a quantity corresponding to time intervals between signal transitions in the demodulated signal; and counting consecutive values of the quantity corresponding to a half-bit duration or a full-bit duration.

In a fifth implementation form of the method, according to the first aspect as such or any preceding implementation form of the first aspect, the method further comprising detecting the start bit in response to the quantity corresponding to the half-bit duration or the full-bit duration.

In a sixth implementation form of the method, according to the first aspect as such or any preceding implementation form of the first aspect, the samples per bit interval of the start bit are at least two, and detecting the start bit comprises applying a threshold-based detection method that maintains consistent detection parameters throughout decoding.

A second aspect relates to a circuit for synchronizing decoding in a wireless power transfer system, the circuit comprising a data retriever circuit configured to extract a signal for a start bit recognition, the signal associated with a demodulated amplitude shift keying (ASK) signal; a start bit recognition circuit coupled to the data retriever circuit and configured to detect a start bit of the signal comprising a biphase mark zero following a preamble sequence of the signal, and generate update signals in response to detecting the start bit; and a controller circuit configured to receive one of the update signals from the start bit recognition circuit and provide samples to a decoder circuit aligned to bit boundaries of subsequent data bits following the start bit.

In a first implementation form of the circuit, according to the second aspect as such, the start bit recognition circuit comprises a comb filter configured to calculate a difference between a current sample of the demodulated ASK signal and a sample delayed by half a bit interval; and detect the start bit in response to the difference being within a threshold range for a predetermined number of consecutive samples.

In a second implementation form of the circuit, according to the second aspect as such or any preceding implementation form of the second aspect, the start bit recognition circuit comprises a moving sum filter configured to accumulate samples of a demodulation-related waveform over a bit interval; and a comparator configured to detect the start bit in response to an output of the moving sum filter being outside a threshold range.

In a third implementation form of the circuit, according to the second aspect as such or any preceding implementation form of the second aspect, the data retriever circuit detects the preamble sequence in the demodulated ASK signal, wherein the preamble sequence comprises consecutive binary ones encoded using biphase mark coding, the data retriever circuit comprising a second circuit configured to extract a quantity corresponding to time intervals between signal transitions in the demodulated ASK signal; and a counter configured to count consecutive values of the quantity corresponding to a half-bit duration or a full-bit duration.

In a fourth implementation form of the circuit, according to the second aspect as such or any preceding implementation form of the second aspect, the start bit recognition circuit is configured to detect the start bit in response to the quantity corresponding to the half-bit duration or the full-bit duration, the start bit recognition circuit is configured to process at least two samples per bit interval, and the start bit recognition circuit is configured to detect the start bit using direct threshold-based detection.

In a fifth implementation form of the circuit, according to the second aspect as such or any preceding implementation form of the second aspect, the circuit further comprising the decoder circuit configured to receive samples from the controller circuit and decode the samples to extract digital information; and a bitstream generator circuit configured to receive decoded information from the decoder circuit and generate one or more bitstreams.

In a sixth implementation form of the circuit, according to the second aspect as such or any preceding implementation form of the second aspect, the start bit recognition circuit is further configured to provide update signals to the decoder circuit and the bitstream generator circuit to synchronize operations of the decoder circuit and the bitstream generator circuit to the bit boundaries.

A third aspect relates to a device for wireless power transfer, the device comprising an amplitude shift keying (ASK) digital signal processing (DSP) circuit configured to generate a demodulated ASK signal from an ASK modulated signal, wherein carrier modulation is handled by a power receiver external to the device; a controller circuit coupled to the ASK DSP circuit; a decoder circuit coupled to the controller circuit; a bitstream generator circuit coupled to the decoder circuit; a data retriever circuit coupled to the ASK DSP circuit, the controller circuit, and the decoder circuit, the data retriever circuit configured to extract a signal for a start bit recognition and associated with the demodulated ASK signal; and a start bit recognition circuit coupled to the data retriever circuit and configured to detect a start bit comprising a biphase mark zero following a preamble sequence of the signal, and provide update signals to the controller circuit, the decoder circuit, and the bitstream generator circuit in response to detecting the start bit to synchronize decoding operations to bit boundaries of subsequent data bits following the start bit.

In a first implementation form of the device, according to the third aspect as such, the start bit recognition circuit comprises a comb filter configured to calculate a difference between a current sample of the demodulated ASK signal and a sample delayed by half a bit interval; and detect the start bit in response to the difference being within a threshold range for a predetermined number of consecutive samples.

In a second implementation form of the device, according to the third aspect as such or any preceding implementation form of the third aspect, the start bit recognition circuit comprises a moving sum filter configured to accumulate samples of a demodulation-related waveform over a bit interval; and a comparator configured to detect the start bit in response to an output of the moving sum filter being outside a threshold range.

In a third implementation form of the device, according to the third aspect as such or any preceding implementation form of the third aspect, the data retriever circuit comprises a circuit configured to extract a quantity corresponding to time intervals between signal transitions in the demodulated ASK signal; and a counter configured to count consecutive values of the quantity corresponding to a half-bit duration or a full-bit duration.

In a fourth implementation form of the device, according to the third aspect as such or any preceding implementation form of the third aspect, the start bit recognition circuit is configured to detect the start bit in response to the quantity value corresponding to the half-bit or the full-bit duration, the start bit recognition circuit is configured to utilize at least two samples per bit interval, and the start bit recognition circuit is configured to employ direct threshold-based detection on demodulated samples.

In a fifth implementation form of the device, according to the third aspect as such or any preceding implementation form of the third aspect, the device further comprising a byte de-serializer circuit coupled to the bitstream generator circuit and configured to group bits into bytes according to the serial communication protocol of the Qi standard and perform error checks on the grouped bytes.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

The specification and drawings are, accordingly, to be regarded simply as an illustration of the disclosure as defined by the appended claims, and are contemplated to cover any and all modifications, variations, combinations, or equivalents that fall within the scope of the present disclosure.

What is claimed is:

1. A method for demodulating and decoding a signal in a wireless power transfer system, the method comprising:
detecting a preamble sequence by processing a demodulated signal corresponding to a demodulation of an amplitude shift keying (ASK) modulated signal, the preamble sequence comprising a series of consecutive binary ones encoded using biphase mark coding;
monitoring for a start bit in response to detecting the preamble sequence, wherein the start bit comprises a binary zero following the preamble sequence; and
performing decoding aligned to bit boundaries of subsequent data bits following the start bit.

2. The method of claim 1, further comprising:
verifying, while monitoring for the start bit, that the preamble sequence continues to be received; and
continue detecting the preamble sequence in response to the preamble sequence no longer being detected.

3. The method of claim 1, further comprising calculating a difference between a current sample of the demodulated signal and a sample delayed by half a bit interval, wherein detecting the start bit is in response to the difference being within a threshold range for a predetermined number of consecutive samples.

4. The method of claim 1, further comprising:
accumulating, by a moving sum filtering, samples of a demodulation-related waveform over a bit interval; and
detecting the start bit in response to a result of the moving sum filtering being outside a threshold range.

5. The method of claim 1, further comprising:
extracting a quantity corresponding to time intervals between signal transitions in the demodulated signal; and
counting consecutive values of the quantity corresponding to a half-bit duration or a full-bit duration.

6. The method of claim 5, further comprising detecting the start bit in response to the quantity corresponding to the half-bit duration or the full-bit duration.

7. The method of claim 1,
wherein the samples per bit interval of the start bit are at least two, and
wherein detecting the start bit comprises applying a threshold-based detection method that maintains consistent detection parameters throughout decoding.

8. A circuit for synchronizing decoding in a wireless power transfer system, the circuit comprising:
a data retriever circuit configured to extract a signal for a start bit recognition, the signal associated with a demodulated amplitude shift keying (ASK) signal;
a start bit recognition circuit coupled to the data retriever circuit and configured to:
detect a start bit of the signal comprising a biphase mark zero following a preamble sequence of the signal, and
generate update signals in response to detecting the start bit; and
a controller circuit configured to receive one of the update signals from the start bit recognition circuit and provide samples to a decoder circuit aligned to bit boundaries of subsequent data bits following the start bit.

9. The circuit of claim 8, wherein the start bit recognition circuit comprises a comb filter configured to:
calculate a difference between a current sample of the demodulated ASK signal and a sample delayed by half a bit interval; and
detect the start bit in response to the difference being within a threshold range for a predetermined number of consecutive samples.

10. The circuit of claim 8, wherein the start bit recognition circuit comprises:
a moving sum filter configured to accumulate samples of a demodulation-related waveform over a bit interval; and
a comparator configured to detect the start bit in response to an output of the moving sum filter being outside a threshold range.

11. The circuit of claim 8, wherein the data retriever circuit detects the preamble sequence in the demodulated ASK signal, wherein the preamble sequence comprises consecutive binary ones encoded using biphase mark coding, the data retriever circuit comprising:
a second circuit configured to extract a quantity corresponding to time intervals between signal transitions in the demodulated ASK signal; and
a counter configured to count consecutive values of the quantity corresponding to a half-bit duration or a full-bit duration.

12. The circuit of claim 11,
wherein the start bit recognition circuit is configured to detect the start bit in response to the quantity corresponding to the half-bit duration or the full-bit duration,
wherein the start bit recognition circuit is configured to process at least two samples per bit interval, and
wherein the start bit recognition circuit is configured to detect the start bit using direct threshold-based detection.

13. The circuit of claim 8, further comprising:
the decoder circuit configured to receive samples from the controller circuit and decode the samples to extract digital information; and
a bitstream generator circuit configured to receive decoded information from the decoder circuit and generate one or more bitstreams.

14. The circuit of claim 13, wherein the start bit recognition circuit is further configured to provide update signals to the decoder circuit and the bitstream generator circuit to synchronize operations of the decoder circuit and the bitstream generator circuit to the bit boundaries.

15. A device for wireless power transfer, the device comprising:
an amplitude shift keying (ASK) digital signal processing (DSP) circuit configured to generate a demodulated ASK signal from an ASK modulated signal, wherein carrier modulation is handled by a power receiver external to the device;
a controller circuit coupled to the ASK DSP circuit;
a decoder circuit coupled to the controller circuit;
a bitstream generator circuit coupled to the decoder circuit;
a data retriever circuit coupled to the ASK DSP circuit, the controller circuit, and the decoder circuit, the data retriever circuit configured to extract a signal for a start bit recognition and associated with the demodulated ASK signal; and
a start bit recognition circuit coupled to the data retriever circuit and configured to:
detect a start bit comprising a biphase mark zero following a preamble sequence of the signal, and
provide update signals to the controller circuit, the decoder circuit, and the bitstream generator circuit in response to detecting the start bit to synchronize decoding operations to bit boundaries of subsequent data bits following the start bit.

16. The device of claim 15, wherein the start bit recognition circuit comprises a comb filter configured to:
calculate a difference between a current sample of the demodulated ASK signal and a sample delayed by half a bit interval; and
detect the start bit in response to the difference being within a threshold range for a predetermined number of consecutive samples.

17. The device of claim 15, wherein the start bit recognition circuit comprises:
a moving sum filter configured to accumulate samples of a demodulation-related waveform over a bit interval; and
a comparator configured to detect the start bit in response to an output of the moving sum filter being outside a threshold range.

18. The device of claim 15, wherein the data retriever circuit comprises:
a circuit configured to extract a quantity corresponding to time intervals between signal transitions in the demodulated ASK signal; and
a counter configured to count consecutive values of the quantity corresponding to a half-bit duration or a full-bit duration.

19. The device of claim 18,
wherein the start bit recognition circuit is configured to detect the start bit in response to the quantity value corresponding to the half-bit or the full-bit duration,
wherein the start bit recognition circuit is configured to utilize at least two samples per bit interval, and
wherein the start bit recognition circuit is configured to employ direct threshold-based detection on demodulated samples.

20. The device of claim 15, further comprising a byte de-serializer circuit coupled to the bitstream generator circuit and configured to group bits into bytes according to the serial communication protocol of the Qi standard and perform error checks on the grouped bytes.
